(19) United States
(12) Patent Application Publication
(10) Pub. No.: US 2003/0094580 A1
(43) Pub. Date: May 22, 2003

(54) Device for detecting objects under insufficient lighting conditions

(76) Inventor: Antonello Caravita, Lugano (CH)

Correspondence Address: James V. Costigan, Esq., Hedman & Costing, P.C., Suite 2003, 1185 Avenue of the Americas, New York, NY, 10036-2646, US

(21) Appl. No.: 10/190,788

(22) Filed: Jul. 8, 2002

(30) Foreign Application Priority Data
Nov. 16, 2001 (IT) MI2001U 000609

(51) Int. Cl. F21K 2/00

(52) U.S. Cl. 250/466.1

(57) ABSTRACT

A device for detecting objects under insufficient lighting conditions comprises a body having a phosphorescent pigmentation and means for fixing the body to an object to be detected.

### BACKGROUND OF THE INVENTION

The present invention relates to a device for detecting objects under insufficient lighting conditions.

As is known, it is frequently necessary to detect objects or other driving elements, under insufficient light conditions or in the dark.

Eyeglasses, watches, keys and locks thereinto said keys must be engaged, could not be seen under insufficient light conditions, thereby causing discomfort or dangerous conditions.

### SUMMARY OF THE INVENTION

The aim of the present invention is to provide such a device for detecting objects under insufficient lighting conditions.

Within the scope of the above mentioned aim, a main object of the present invention is to provide such a detecting device which is very simple and flexible in operation, and which can be applied to any types of objects for allowing said objects to be easily detected under insufficient lighting condition.

Another object of the present invention is to provide such a detecting device which is very inexpensive and does not require maintenance works.

Yet another object of the present invention is to provide such a detecting device which is very reliable and safe in operation.

According to one aspect of the present invention, the above mentioned aim and objects, as well as yet other objects, which will become more apparent hereinafter, are achieved by a device for detecting objects, under insufficient lighting conditions, characterized in that said device comprises a body having a phosphorescent pigmentation and clamping means for clamping said body to an object to be detected.

### BRIEF DESCRIPTION OF THE DRAWINGS

Further characteristics and advantages of the present invention will become more apparent hereinafter from the following detailed disclosure of a preferred, though not exclusive, embodiment of the invention, which is illustrated, by way of an indicative, but not limitative, example in the accompanying drawings, where:

FIG. 1 is a perspective view of a device according to the invention, comprising a resilient rubber ring element;

FIG. 2 is a perspective view showing a possible application of the ring element shown in FIG. 1 to an eyeglass arm;

FIG. 3 is a further perspective view of an electric switch panel, including a detecting device according to the present invention;

FIG. 4 is a further perspective view of a key, including a detecting device according to the invention;

FIG. 5 is a further perspective view of a detecting device according to the present invention, comprising an adhesive disc element;

FIG. 6 is a perspective view of a wall and a door, including detecting device according to the present invention;

FIG. 7 is yet another perspective view showing the detecting device according to the present invention, which can be applied to a balustrade of a ladder, for indicating the presence of said ladder;

FIG. 8 shows the above mentioned ring element applied to a rear fender of a bicycle;

FIG. 9 shows the ring element applied to a driving tie-rod of a lamp;

FIG. 10 shows the ring element applied to a bottle;

FIG. 11 shows the same ring element applied to a telephone handset;

FIG. 12 shows a pair of ring elements, applied to a pair of slippers for indicating the presence of said slippers in night time;

FIG. 13 shows a phosphorescent resilient ring element applied to a remote control unit;

FIG. 14 shows the same ring element applied to an electric flashlight;

FIG. 15 shows that same ring element applied to a leg of a table;

FIG. 16 shows that same ring element applied to a handle of a door;

FIG. 17 shows that same ring element applied to the handrail of a balustrade;

FIG. 18 shows that same ring element applied, as a frame, to a panel including a plurality of switches;

FIG. 19 shows that same ring element having a circular cross-section;

FIG. 20 shows that same ring element having a polygonal cross-section; and

FIG. 21 shows that same ring element having an elliptical cross-section.

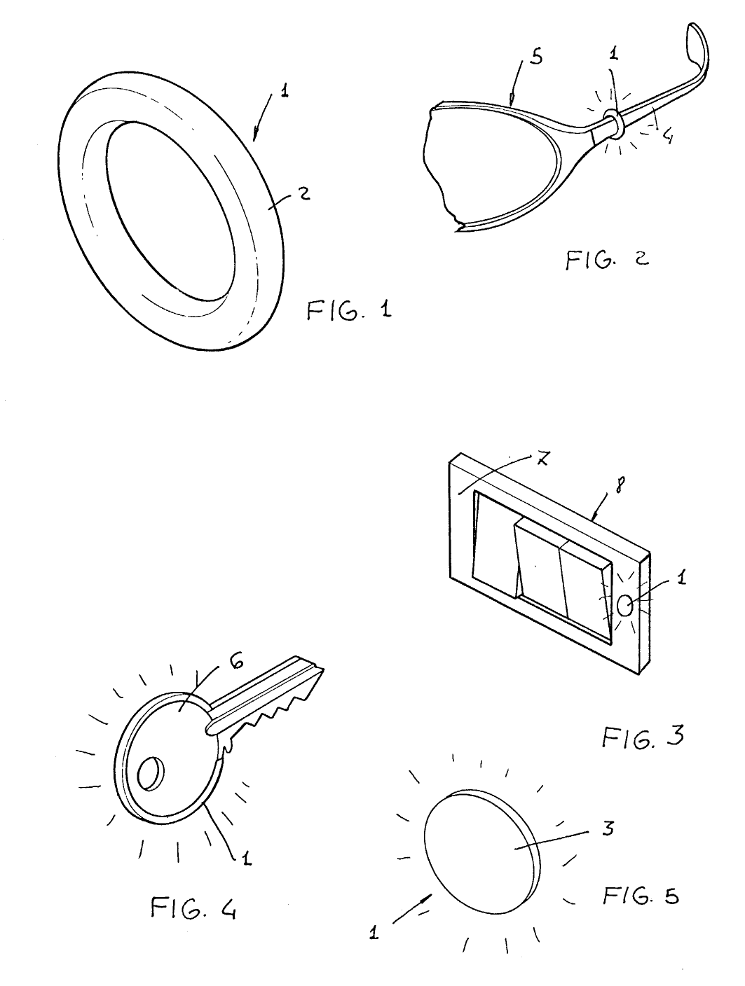

### DESCRIPTION OF THE PREFERRED EMBODIMENTS

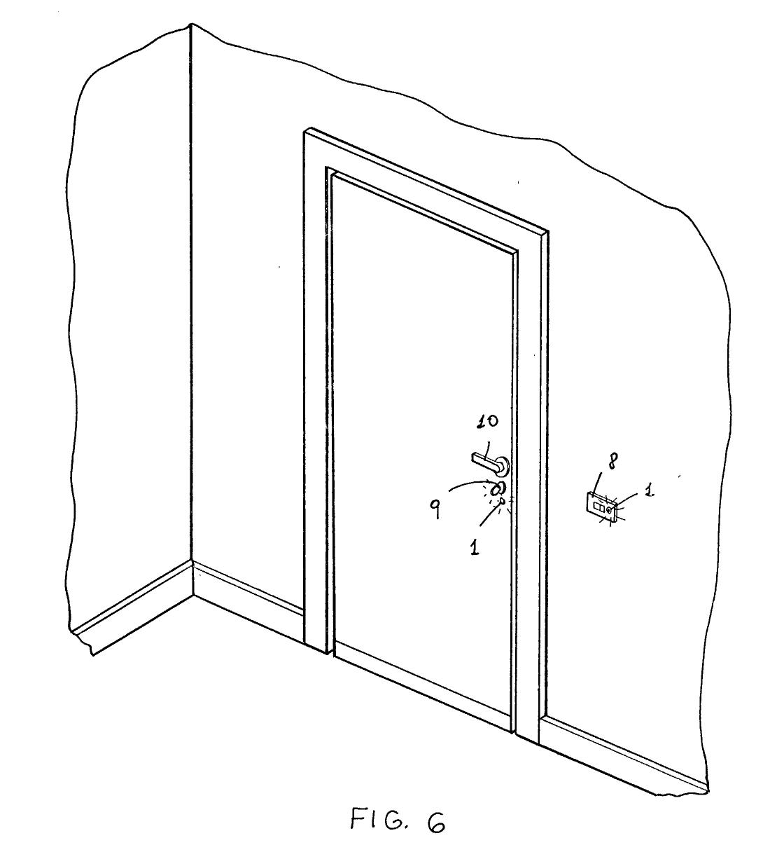

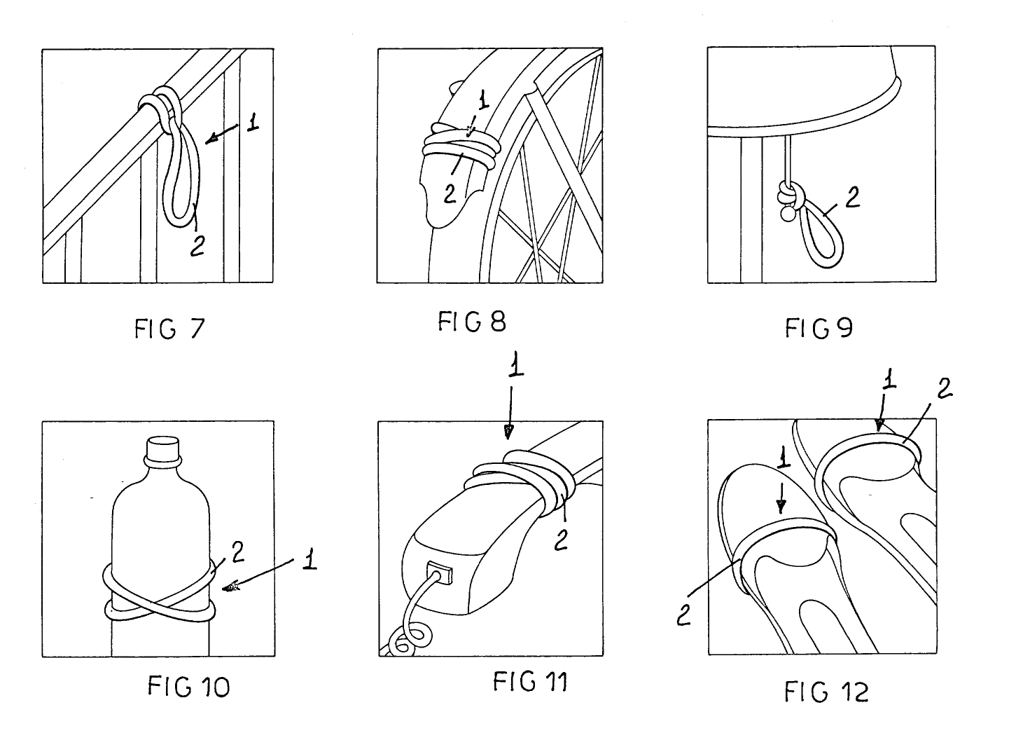

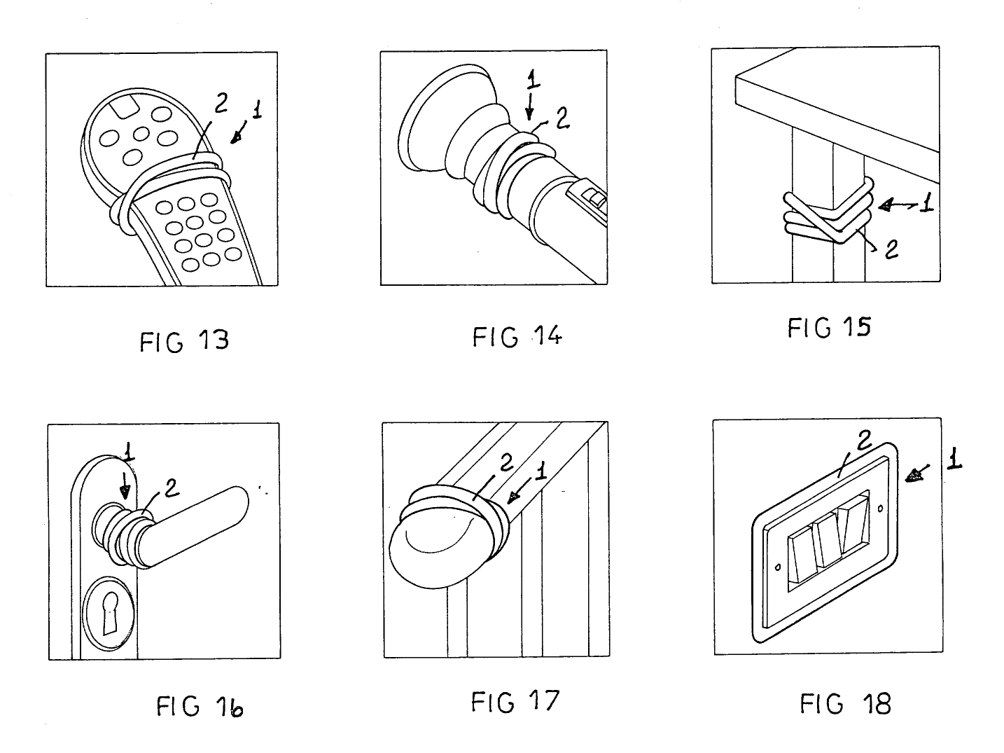

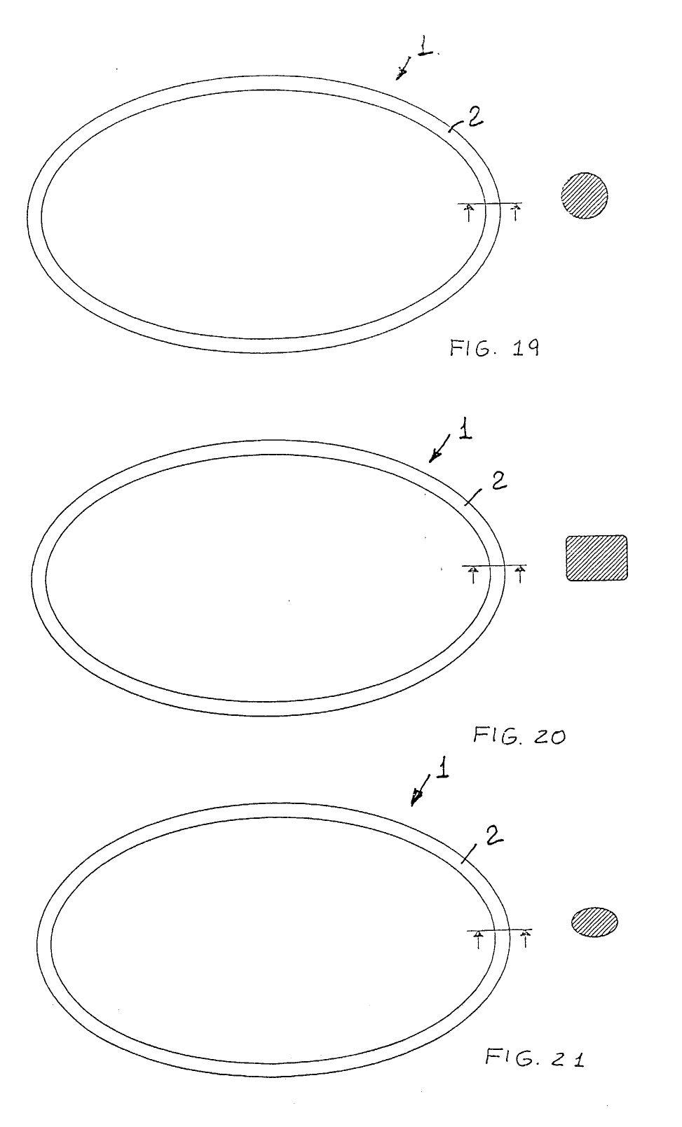

With reference to the number references of the above mentioned figures, the detecting or signalling device according to the present invention, which has been generally indicated by the reference number 1, can have a ring-like shape 2, the ring being made of rubber or any other suitable resilient material, as shown in FIG. 1, or it can have a disc-like shape 3, also made of an elastomeric or plastic material, having an adhesive surface, as shown in FIG. 5.

According to the present invention, the device 1 comprises a phosphorescent pigmentation, to easily detect objects or articles in poorly lightened environments.

In its elastomeric ring configuration 2, the device can be advantageously applied to several objects or articles, even if the latter are not provided for such an application, such as, for example, to an arm 4 of an eyeglass 5, as shown in FIG. 2, or to a key 6, as shown FIG. 4.

In this connection, it should be apparent that the above application examples have been herein illustrated merely by a non limitative example, and they must not be deemed as exhaustive of a lot of possible practical applications, and this owing to the advantageous construction of the device according to the invention.

In its adhesive disc configuration 3, the device can be advantageously applied, for example, to the plate 7 of a wall switch 8, or at the key plate or lock 9 of a door 11, or to the handle 10 of said door.

In its elastomeric material ring configuration, the device according to the present invention can be further applied in yet other applications, in addition to the above illustrated applications.

By way of an example, the device can be applied on door handles or knobs or on any other driving element to be detected in a dark environment, on watch bracelets, on radio set, on shoes, on motorcycle or bicycle portions, on jogging shoes, on wrists or ankles, on fishing net floats, on shoe cords, on dog and cat collars and on fittings therefor.

As shown, the subject device has a sufficiently elongated configuration, so as to be easily wrapped in envelopes and to be easily applied to a lot of different objects.

The ring element, in its elongated configuration, can have either a circular, elliptic or a polygonal cross-section.

To that end, the ring element according to the invention must have a comparatively high elasticity and flexibility, so as to allow it to be easily knotted or wound on different objects.

Thus, owing to its comparatively high resilient properties, the ring element can be subjected to pulling forces, to be properly elongated and then tightly and firmly clamped on the objects to be detected, to which it can perfectly adhere.

It has been found that the invention fully achieves the intended aim and objects.

In fact, the invention provides a constructionally simple and flexible device which can be virtually applied to any type of desired objects, even if the latter have not been set for such an application, and moreover it can be shaped as a frame, to allow the objects to be easily detected under insufficient or inexistent lighting condition.

In practicing the invention, the used materials, and their contingent size and shapes, can be any, depending on requirements and the status of the art.

1. A device for detecting objects under insufficient lighting condition, characterized in that said device comprises a body having a phosphorescent pigmentation and clamping means for clamping said body to an object to be detected.

2. A device, according to claim 1, characterized in that said body comprises a ring element made of a rubber or other elastomeric material, the elasticity of which provides a clamping means.

3. A device, according to claim 1, characterized in that said body comprises a disc, a plate, a plug, a frame shaped element and the like, made of an elastomeric or plastic material, and having an adhesive surface forming said clamping means.

4. A device, according to one or more of the preceding claims, characterized in that the ring-like body is so designed as to aesthetically fit the contour of the object to which it must be applied.

5. A device, according to one or more of the preceding claims, characterized in that said ring-like body comprises an inner annular groove for receiving therein an edge of a key grip portion or the like.

6. A device for detecting objects under insufficient lighting conditions, according to one or more of the preceding claims, characterized in that said device comprises an elongated plastic material body, having a phosphorescent pigmentation and high elasticity characteristics under pulling stresses, to be easily applied and knotted to an object to be detected.

7. A device, according to one or more of the preceding claims, characterized in that said device can advantageously be applied to an eyeglass arm, a key, a ladder balustrade, a rear fender of a bicycle or to a driving tie-rod of a lamp.

8. A device, according to one or more of the preceding claims, characterized in that said device, in its elongated ring-like configuration, can be applied to bottles or other vessels, or a telephone handset, or to a pair of slippers of shoes, thereby allowing to detect the presence of these articles under poor environmental lighting condition.

9. A device, according to one or more of the preceding claims, characterized in that said device has such an elasticity as to allow said device to be wound on a remote control unit, a lamp, a leg of a table or a handle of a door, or to a handrail of a ladder.

10. A device, according to one or more of the preceding claims, characterized in that said device can be applied to watch bracelets.

11. A device, according to one or more of the preceding claims, characterized in that said device can be applied to the keyhole plate or lock of a door, to facilitate the detection of the latter under insufficient lighting conditions.

12. A device for detecting objects under insufficient lighting conditions, characterized in that said device has an elongated configuration, with a circular, elliptical or polygonal cross-section.

13. A device for detecting objects, characterized in that said device can be elongated from 1 to 5 times, under a pulling stress, and being adapted to be recovered to its starting size.

14. A device, according to one or more of the preceding claims, characterized in that said device can be applied on radio set, shoes, motorcycle and bicycle parts, jogging shoes, ankles or wrists, fishing net floats, shoe cords, dog and cat collars and fittings therefor.
